(19) United States
(12) Patent Application Publication
(10) Pub. No.: US 2010/0012742 A1
(43) Pub. Date: Jan. 21, 2010

(54) RAILWAY TIE USING STRAIN-HARDENING BRITTLE MATRIX COMPOSITES

(76) Inventor: Victor C. Li, Ann Arbor, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/503,459

(22) Filed: Jul. 15, 2009

Related U.S. Application Data
(60) Provisional application No. 61/080,839, filed on Jul. 15, 2008.

(51) Int. Cl. E01B 3/32; B29C 39/02; B29C 45/00

(52) U.S. Cl. 238/85; 264/299; 264/328.1

(57) ABSTRACT

Railway tie is based upon a fiber-reinforced brittle matrix composite material. The composite material is isotropic, demonstrating pseudo-strain hardening behavior in uniaxial tension, and material ductility by design, not relying on reinforcing bars or mesh embedded within concrete or other brittle cementitious matrices for durability, abrasion resistance, or crack width control. Reinforcing bars or mesh, pretensioned or otherwise, may be used within the tie to control the load capacity and load-deformation response. The properties of this fiber-reinforced brittle matrix composite material are adjusted to preferably work with casting, injection molding, or extrusion manufacturing methods.

### REFERENCE TO RELATED APPLICATION

This application claims priority from U.S. Provisional Patent Application Ser. No. 61/080,839, filed Jul. 15, 2008, the entire content of which is incorporated herein by reference.

### FIELD OF THE INVENTION

This invention relates generally to railway tie construction and, more particularly, to the use of fiber-reinforced brittle matrix inorganic composites in such applications.

### BACKGROUND OF THE INVENTION

Railway ties are typically made from timber, steel, ordinary concrete (prestressed or otherwise), or plastics (organic or otherwise). These ties are commonly referred to as “sleepers” internationally. In the prior art, these ties have been embedded in rock ballast roadbeds and then have the rails placed on top thereof. The rails are fastened to the ties either through spikes, in the case of wood and plastic ties, or metal fasteners or clips in case of concrete ties. The vast majority of railway ties within the United States are timber which are 6″×8″×8′6″ and 7″×9″×8′6″ for a standard railroad gauge. While the structural properties of timber ties, in particular the flexural stiffness, are desirable in railway applications, the durability of timber railway ties is limited and the availability of hardwood with suitable quality and dimensions is diminishing.

Alternative to wood ties, reinforced concrete ties have been used in the past. However, the concrete may crack in cold weather and any water therein will widen the crack as it freezes. This may further lead to corrosion of steel reinforcing bars in the concrete. Further, the resiliency of concrete ties under heavy abrasion loads by the steel rails, even though bearing pads have been used, has been unsatisfactory. In some cases, the use of non-corrosive reinforcement such as glass-fiber reinforced polymers (FRP) may be used.

To combat the poor durability of reinforced concrete ties which crack under various loads, prestressed concrete ties can have a relatively high durability due to the suppression of cracks in the concrete through use of a prestressing force. However, their flexural stiffness is relatively high and therefore may cause an increased load demand on the tie as well as on the rail. Furthermore, prestressed concrete ties are not suitable for partial replacement of deteriorated timber ties due to incompatibility of their flexural stiffness. Individual tie replacement, rather than complete sections of track, is of particular interest due to the large number of timber ties currently in use. As an illustration, a standard mile of railroad track will contain approximately 3,200 ties therein.

There are numerous inventions aiming at durable railway ties with flexural stiffness similar to that of timber ties. An example of such an invention is disclosed in an International Patent WO 2005/100691, in which the use of concrete with a polymeric binder is disclosed. This invention is based on using particular amounts of a polymeric resin in different parts of the railway tie to achieve the desired stiffness characteristics, which requires the use of special processing equipment and processing methods.

Another invention (U.S. Pat. No. 6,070,806) describes the use of variable cross-section within the railway tie with particular cross-sectional dimensions consisting of various components and materials with a variety of material stiffnesses, such as concrete with a polymeric binder, wooden inserts, and composite material reinforcements. This invention relies on a particular geometry of the components which, when arranged in the appropriate configuration, produce a tie with similar stiffness to a timber tie.

Research findings in the published literature (Sholcrieh and Rahmat, 2006) describe the use of Fiber Reinforced Polymer (FRP) reinforcement substituting steel reinforcement as a means to achieve a flexural stiffness of a reinforced concrete railway tie similar to that of a timber tie. While the combination of concrete with FRP reinforcement will eliminate the potential corrosion problem of the reinforcement, the interfacial bonding between concrete and FRP will deteriorate during the high-cycle fatigue loading process of the railway tie in the service phase.

Other inventions describe the use of plastic or resin encasement to improve the durability of timber ties (U.S. Pat. No. 6,336,265). While other inventions (U.S. Pat. No. 3,416,727) describe the use shredded hardwood fillers and phenol formaldehyde resin in the production of synthetic railway ties with improved durability and similar weight compared to virgin timber ties.

### SUMMARY OF THE INVENTION

The present invention improves upon prior art railway tie technologies by using a cementitious composite material, which is isotropic, ductile, and damage tolerant by design and does not require the application of prestressing forces to avoid localized cracking and achieve a durable railway tie.

This is accomplished with a cementitious composite material, which has been designed to control the formation of cracking and maintain very small crack widths (less that 200 μm) under service loading conditions such as to prevent an uncontrolled ingress of water and provide corrosion protection of the reinforcement. In contrast to existing concrete or cement-based materials, this material can provide such performance without the use of reinforcing bars or mesh (prestressed or otherwise) to control crack width for high durability.

In the preferred embodiments, the cementitious composite material is based upon a fiber-reinforced matrix, cementitious in nature for certain applications, which demonstrates pseudo-strain-hardening behavior in uniaxial tension with random orientation of fibers within the composite to provide tensile load capacity along with impact and abrasion resistance. This cementitious composite material possesses high tensile ductility to allow flexural deformations of the railway tie without causing large cracks or disintegration.

The cementitious composite material can be applied using conventional casting processes into the railway tie formwork independent of the particular shape or size of the railway tie. The cementitious composite material may also be injection molded or extruded into a designed cross-sectional geometry for the railway tie application.

If necessary to overcome existing concerns of excessive abrasion of the tie material in locations directly under or under direct load from the rail or rail pads (common called rail seat abrasion) individual “seats” of steel, composite, or other material may be molded or cast into place.

To control the structural stiffness of the tie, the cementitious composite material can be used in combination with various types of structural reinforcement including but not limited to mild steel, prestressing steel (with application prestressing force or otherwise), or Fiber Reinforced Polymers (FRP).

According to one aspect of the invention there is provided a railway tie of any size and shape, which is produced with the fiber-reinforced pseudo-strain-hardening brittle matrix composite. This composite material does not rely on reinforcing bars embedded within composite for bending resistance, impact resistance, fracture toughness, or crack width control.

### BRIEF DESCRIPTION OF THE DRAWINGS

FIG. 1 illustrates a stress strain curve for one embodiment of a pseudo-strain-hardening brittle matrix composite used in the present invention;

FIG. 2 illustrates the railway tie according to the present invention;

FIG. 3 illustrates the perspective view of one potential manufacturing process;

FIG. 4 illustrates the perspective view of a second potential manufacturing process;

FIG. 5 illustrates the perspective view of a third potential manufacturing process;

FIG. 6 illustrates the perspective view of a fourth potential manufacturing process; and

FIG. 7 illustrates the perspective view of a fifth potential manufacturing process.

### DETAILED DESCRIPTION OF THE INVENTION

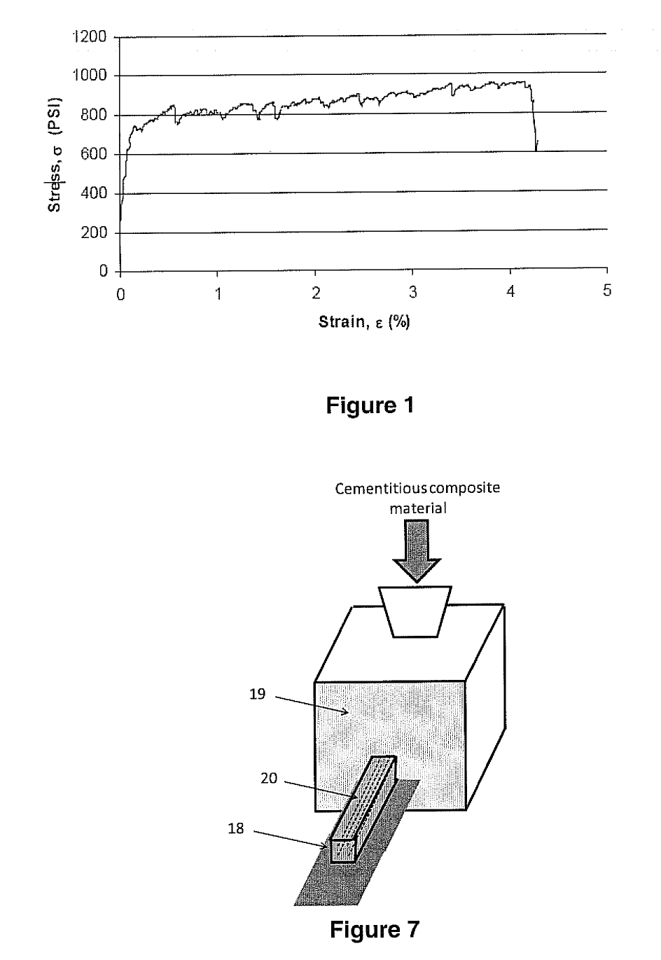

Referring to FIG. 1, the preferred embodiment of the invention uses a fiber reinforced matrix as a railway tie material. This material, which is cementitious in nature for certain applications, exhibits pseudo-strain-hardening properties when loaded in uniaxial tension. Details of the material itself may be found in Li, V. C., “On Engineered Cementitious Composites (ECC)—A Review of the Material and its Applications,” J. Advanced Concrete Technology, Vol. 1, No. 3, pp. 215-230, 2003, the entire content of which is incorporated herein by reference. The pseudo-strain-hardening behavior of the preferred material is marked by forming a distribution of tightly spaced microcracks in the strain-hardening deformation range with maximum crack widths not to exceed 200 μm to accommodate macroscopic tensile, bending, or shear deformation without forming large localized cracks in excess of 200 μm in width.

When cementitious in nature, fiber reinforced brittle matrix composites may be formed of a mixture of cementitious materials, inert fillers, reinforcing fibers, water, and processing chemical additives. The term “cementitious” includes conventional cements and mixtures thereof, and other building compositions that rely on hydraulic curing mechanisms. Examples of such materials include, but are not limited to, lime cement, Portland cement, refractory cement, slag cement, expansive cement, pozzolanic cements, industrial slags, industrial fly ash, mixtures of cements, etc. The term “inert fillers” includes, but is not limited to, natural sands, metal or other powders, industrial wastes, processed aggregates, etc. The term “fibers” includes, but is not limited to, metallic fibers, polymeric fibers, inorganic fibers, and natural fibers, etc. any of which are used for structural reinforcement or fracture suppression within the brittle matrix. The term “processing chemical additives” includes, but is not limited to, stabilizing admixtures, derivatized celluloses, and superplasticizers.

A specific example of a composition for this fiber reinforced brittle matrix composite, expressed as a weight ratio, unless otherwise indicated, is as follows:

| Cement¹ | Sand² | Fly Ash³ | Water | HRWR⁴ | Fiber (vol %)⁵ |
|---|---|---|---|---|---|
| 1 | 0.8 | 1.2 | 0.54 | 0.013 | 2.0 |

¹Ordinary Portland Cement Type I (average particle diameter size = 11.7 ± 6.8 μm, LaFarge, Co.
²Silica Sand (average particle diameter = 110 ± 6.8 μm, U.S. Silica Corp.)
³Fly Ash (average particle diameter = 2.4 ± 1.6 μm, Boral Material Technologies, Inc.)
⁴High Range Water Reducer (Polycarboxylate-based superplasticizer, W. R. Grace Chemical Co.)
⁵Poly-vinyl-alcohol fibers (average length = 6-8 mm, average diameter = 39 μm ± 6 μm, Kuraray Company, Ltd.)

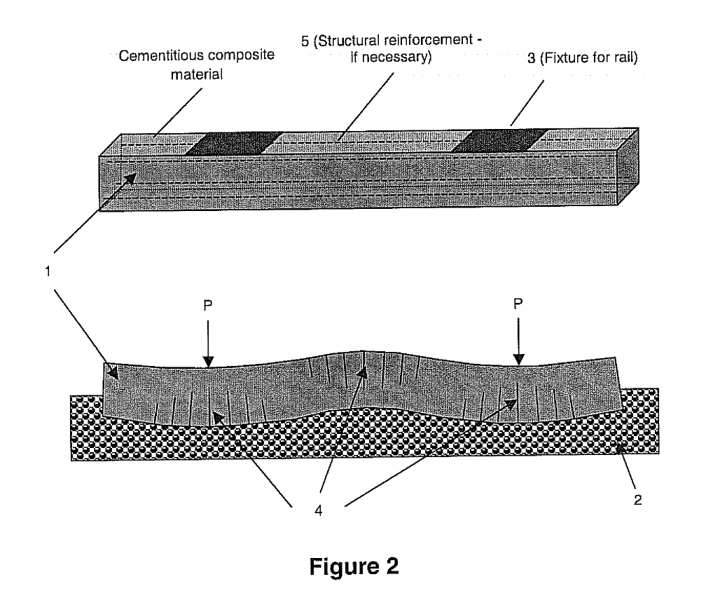

FIG. 2 illustrates an application of the invention to a railway tie of general size and shape intended to support the rails. The railway tie I is embedded in a rock ballast roadbed 2 and then has the rails placed on top thereof at the rail seat locations 3 applying a load, P, under rail traffic. As needed, prefabricated or integrally cast rail seats may be used directly under the rails to prevent excessive rail seat abrasion. Inherently controlled microcracking 4 of the composite material is shown due to bending load on the tie. As noted in FIG. 2, to control the structural stiffness of the tie, the cementitious composite material can be used in combination with various types of structural reinforcement 5 including but not limited to mild steel, prestressing steel (with application of prestressing force or otherwise), or Fiber Reinforced Polymers (FRP). The cementitious composite material tie may also be left void of structural reinforcement apart from randomly oriented fibers within the composite.

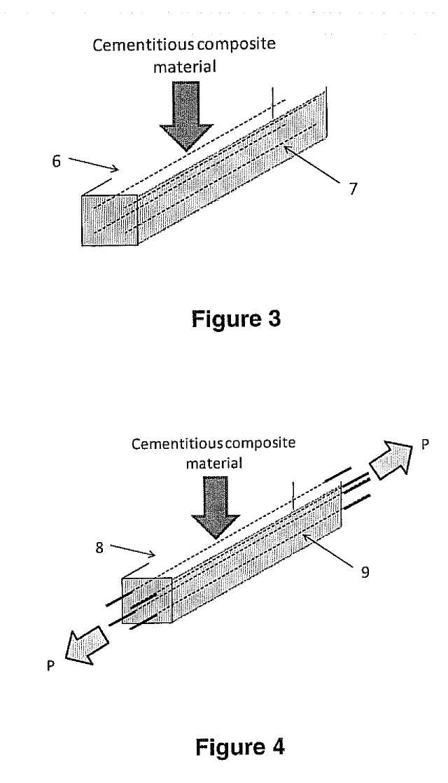

Referring to FIG. 3, the present invention may be manufactured using conventional casting molds 6 (heated or unheated) for embodiments using conventional (non-prestressed) reinforcements 7 or for unreinforced embodiments.

Referring to FIG. 4, the present invention may be manufactured using conventional tensioning bends S (heated or unheated) for embodiments using prestressing steel reinforcement 9 tensioned using prestressing force, P.

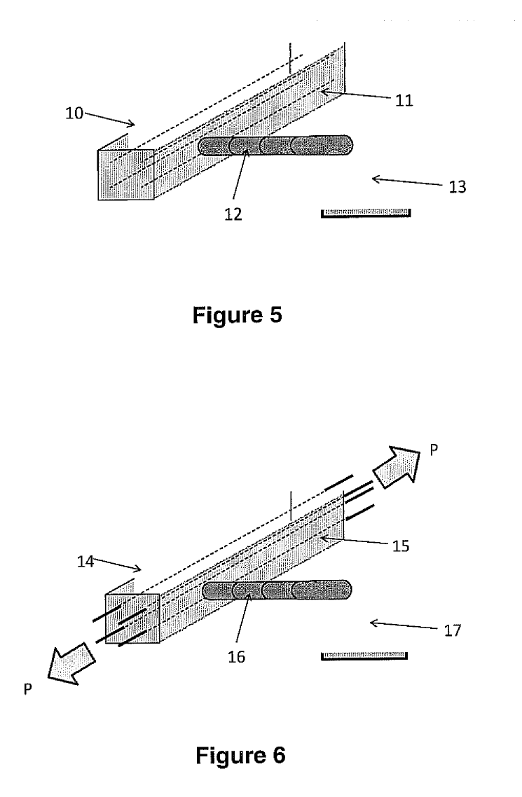

Referring to FIG. 5, the present invention may be manufactured using a closed casting form 10 containing non-prestressed reinforcement 11 which is filled with composite material through an external hose 12 and pump 13 via injection molding techniques (heated or unheated) for the non-prestressed or unreinforced embodiments.

Referring to FIG. 6, the present invention may be manufactured using a closed casting form 14 containing prestressed reinforcement 15, tensioned using prestressing force, P, which is filled with composite material through an external hose 16 and pump 17 via injection molding techniques (heated or unheated) for the prestressed embodiment.

Referring to FIG. 7, the present invention 18 may be manufactured using extrusion techniques and equipment 19 (heated or unheated) for embodiments using non-prestressed reinforcement 20, or for embodiments that are unreinforced or prestressed.

What is claimed is:

1. A railway tie or sleeper, comprising:
an elongate body having a length and an upper surface; and
wherein the body is fabricated from fiber-reinforced brittle matrix composite material of the type that exhibits pseudo-strain-hardening behavior in uniaxial tension by developing a series of microcracks rather than localized fractures in response to deformation.

2. The railway tie or sleeper of claim 1, wherein the composite material is cementitious in nature.

3. The railway tie or sleeper of claim 1, further including external or embedded reinforcement members oriented lengthwise on or within the body.

4. The railway tie or sleeper of claim 17 further including continuous bars, mesh, strands, or fabrics disposed on or within the body.

5. The railway tie or sleeper of claim 1, further including members made of mild steel, prestressed steel or fiber reinforced polymers disposed on or within the body.

6. The railway tie or sleeper of claim 1, further including a pair of spaced-apart prefabricated or integrally cast rail seats disposed on the upper surface of the body.

7. A method of fabricating a railway tie or sleeper, comprising the steps of:
forming an elongate body having a length and an upper surface using a cementitious, fiber-reinforced brittle matrix composite material of the type that exhibits pseudo-strain-hardening behavior in uniaxial tension by developing a series of microcracks rather than localized fractures in response to deformation.

8. The method of claim 7, including the step of using heated or unheated casting to form the body.

9. The method of claim 7, including the step of using heated or unheated tensioning bends to form the body.

10. The method of claim 7, including the step of injection molding the body.

11. The method of claim. 7, including the step of extruding the body.

12. The method of claim 7, including the step of providing external or embedded reinforcement members lengthwise on or within the body.

13. The method of claim 7, including the step of providing continuous bars, mesh, strands, or fabrics disposed on or within the body.

14. The method of claim 7, including the step of providing members made of mild steel, prestressed steel or fiber reinforced polymers disposed on or within the body.

15. The method of claim 7, including the step of prefabricating or integrally casting a pair of opposing rail seats on the upper surface of the body.

16. The method of claim 7, further including the steps of:
fabricating a plurality of bodies with the fiber-reinforced brittle matrix composite material; and
arranging the individual pieces for use as a railway support structure.

17. A railway constructed in accordance with the method of claim 16.
